(19) United States
(12) Patent Application Publication
(10) Pub. No.: US 2014/0281488 A1
(43) Pub. Date: Sep. 18, 2014

(54) System and Method for Offloading Cryptographic Functions to Support a Large Number of Clients in a Wireless Access Point

(71) Applicant: Aruba Networks, Inc., Sunnyvale, CA (US)

(72) Inventors: Jie Jiang, San Jose, CA (US); Kalyan Dharanipragada, Sunnyvale, CA (US); Steve Alexander, Woodside, CA (US)

(73) Assignee: Aruba Networks, Inc., Sunnyvale, CA (US)

(21) Appl. No.: 13/931,628

(22) Filed: Jun. 28, 2013

Related U.S. Application Data
(60) Provisional application No. 61/794,652, filed on Mar. 15, 2013.

(51) Int. Cl. H04L 29/06

(52) U.S. Cl. CPC H04L 63/0471
USPC 713/153

(57) ABSTRACT

The present disclosure discloses a method and network device for offloading cryptographic functions to support a large number of clients. Specifically, a network device receives a packet corresponding to a client device via an interface, and determines whether a first hardware module that performs cryptographic operations on a per-client basis overflows. If first hardware module overflows, the network device retrieves a cryptographic key for the packet, and sends the received packet with the retrieved cryptographic key to a second hardware module that performs cryptographic operations on a per-packet basis to perform one or more cryptographic operations. If not, the network device sends the packet to the first hardware module to perform the one or more cryptographic operations.

### CROSS-REFERENCE TO RELATED APPLICATIONS

This application claims the benefit of U.S. Provisional Patent Application Ser. No. 61/794,652, filed on Mar. 15, 2013, the entire contents of which are incorporated by reference.

### FIELD

The present disclosure relates to wireless cryptography. In particular, the present disclosure relates to offloading cryptographic functions to support a large number of clients in a wireless access point.

### BACKGROUND

An application-specific integrated circuit (ASIC) is an integrated circuit (IC) that is customized for a particular use, rather than intended for general-purpose use. For example, a chip designed to provide wireless local area network (WLAN) access according to IEEE 802.11 standard can be a WLAN ASIC.

For any packet that needs to be transmitted securely by an access point in a wireless network, the ASIC of the access point will perform one or more cryptographic functions. In order to do so, the ASIC can access a cryptographic key based on a unique identifier associated with a particular client, e.g., the Media Access Control (MAC) address of the client. The mapping between the unique client identifier and the cryptographic key to be used for packets to/from the client is typically stored by ASIC in a high-performance memory. Because the WLAN ASIC is a hardware chip designed to provide fast wireless access service, the size of the high-performance memory is usually quite limited. As a result, the number of clients that the access point can support is limited by the number of cryptographic keys that can be stored in the high-performance memory by the WLAN ASIC.

Conventionally, in order to support a large number of clients in a wireless access point, the access point may use a software module to process the overflow cryptographic functions when the clients requires more cryptographic keys than the hardware module (e.g., the high-performance memory) can handle. However, the software-based approach is often associated with degraded performance.

### BRIEF DESCRIPTION OF THE DRAWINGS

The present disclosure may be best understood by referring to the following description and accompanying drawings that are used to illustrate embodiments of the present disclosure.

FIG. 1 is a diagram illustrating an exemplary wireless access point according to embodiments of the present disclosure.

FIG. 2 illustrates an exemplary key table used by the WLAN ASIC according to embodiments of the present disclosure.

FIG. 3 illustrates an exemplary hardware security engine module according to embodiments of the present disclosure.

FIG. 4 illustrates an exemplary hardware security engine module according to embodiments of the present disclosure.

FIG. 5 is a flowchart illustrating an exemplary process for offloading cryptographic functions to support a large number of clients in a wireless access point according to embodiments of the present disclosure.

### DETAILED DESCRIPTION

In the following description, several specific details are presented to provide a thorough understanding. While the context of the disclosure is directed to offloading cryptographic functions to support a large number of clients in a wireless access point, one skilled in the relevant art will recognize, however, that the concepts and techniques disclosed herein can be practiced without one or more of the specific details, or in combination with other components, etc. In other instances, well-known implementations or operations are not shown or described in details to avoid obscuring aspects of various examples disclosed herein. It should be understood that this disclosure covers all modifications, equivalents, and alternatives falling within the spirit and scope of the present disclosure.

### Overview

Embodiments of the present disclosure relate to wireless cryptography. In particular, the present disclosure relates to offloading cryptographic functions to support a large number of clients in a wireless access point. Conventionally, an ASIC chip has limited key storage space, for example, an ASIC chip may support a total of 54 keys, 50 of which are available as client station (STA) keys. A host software driver based encryption will be used for the 51st key during the time when a client station is associated with the wireless access point. Techniques in the present disclosure use hardware acceleration for overflow stations by enhancing an existing security engine. This would allow a large number of stations to be supported by the wireless access point without overloading the main CPU.

With the solution provided herein, a network device receiving a packet corresponding to a client device via an interface. Note that, one or more cryptographic operations are to be performed on the received packet. Further, the network device determines whether a first hardware module that performs cryptographic operations on a per-client basis overflows. If first hardware module overflows, the network device sends the received packet to a second hardware module that performs cryptographic operations on a per-packet basis.

In some embodiments, the first hardware module comprises a wireless local area network (WLAN) application-specific integrated circuit (ASIC); and, the second hardware module comprises a CPU security engine (SEC).

In some embodiments, the network device further determines a client identifier, such as a MAC address that is uniquely associated with the client device, based on the received packet. Also, the WLAN ASIC of the network device retrieves a cryptographic key based on the client identifier from a cryptographic key table stored in a fast memory, and uses the retrieved cryptographic key to perform the one or more cryptographic operations.

In some embodiments, if the first hardware module overflows, the network device retrieves a cryptographic key for the received packet, and sends the received packet and the cryptographic key for the received packet to the second hardware module that uses the cryptographic key for the received packet to perform the one or more cryptographic operations.

In some embodiments, the second hardware module uses a plurality of cipher mechanisms in a plurality of operation modes to support a plurality of wireless network security protocols. Specifically, the wireless network security protocols include, but are not limited to, Internet Protocol Security (IPsec), Internet Key Exchange (IKE), Secure Sockets Layer/Transport Layer Security (SSL/TLS), Internet Small Computer System Interface (iSCSI), Secure Real Time Transport Protocol (SRTP), IEEE 802.111 protocol, Worldwide Interoperability for Microwave Access (WiMAX). The cipher mechanisms include, but are not limited to, Advanced Encryption Standard (AES) and Temporal Key Integration Protocol (TKIP). The operation modes include, but are not limited to, Cipher Block Chaining mode (CBC), electronic codebook (ECB), cipher feedback mode (CFB), output feedback mode (OFB), and counter mode (CTR).

In some embodiments, the second hardware module offloads from the first hardware module computationally intensive security operations comprising key generation and exchange, authentication, bulk encryption from the one or more processing cores. In other embodiments, the second hardware module offloads from the first hardware module security operations corresponding to a plurality of client devices that are associated with light network usages based on their historical network usage information.

In some embodiments, a driver for the second hardware module uses an application programming interface that provides one or more of the following functionalities: creating a cryptographic transform, setting a cryptographic key after key negotiation for an overflow client device is completed, and cipher request on a per-MAC Service Data Unit (MSDU) basis.

### Wireless Access Point Architecture

FIG. 1 shows an exemplary wireless access point according to embodiments of the present disclosure. FIG. 1 includes access point 100 that has at least the following components: a central processing unit (CPU) 110 capable of computing instructions, a security engine 120, an application-specific integrated circuit (ASIC) 130, a wired network interface (e.g., Ethernet port) 170, and a wireless network interface (e.g., antenna) 160. Access point 100 may be deployed in a wireless local area network (WLAN) infrastructure. Also, access point 100 serve as node in a distributed computing system and/or a cloud computing environment.

CPU 110 can include one or more microprocessors and/or network processors. CPU 110 can be coupled to a memory, including one or more of storage components, such as, Dynamic Random Access Memory (DRAM), Static Random Access Memory (SRAM), etc.

Furthermore, ASIC 130 has a radio frequency (RF) front end (FE) module 140 and a wireless local area network (WLAN) ASIC module 150. RF FE 140 is coupled to antenna 160. In a radio receiver circuit, RF front end 140 includes all the circuitry between the antenna and the first intermediate frequency (IF) stage. RF FE 140 consists of all the components in the receiver that process the signal at the original incoming radio frequency (RF), before it is converted to a lower intermediate frequency (IF).

WLAN ASIC 150 is a hardware chip designed to provide wireless local area network (WLAN) access according to IEEE 802.11 standard.

Antenna 160 may be any combination of known or conventional electrical components for receipt of signaling, including but not limited to, transistors, capacitors, resistors, multiplexers, wiring, registers, diodes or any other electrical components known or later become known. Antenna 160 can be switched to any wireless network interface, such as wireless IEEE 802.11 interface (e.g., IEEE 802.11n, IEEE 802.11ac, etc), cellular wireless interface, satellite transmission interface, without departing from the spirit of the present disclosure.

Network interface 170 can be any wired communication interface, which includes but is not limited to, a modem, token ring interface, Ethernet interface, or any other interface for coupling network devices. In some embodiments, network interface 170 may be software-defined and programmable, for example, via an Application Programming Interface (API), and thus allowing for remote control of access point 100.

Security engine 120 is a hardware module that provides hardware acceleration for multiple security protocols, e.g., encryption/decryption and/or authentication protocols, to secure wireless packet transmissions. Specifically, security engine 120 can receive a packet and a cryptographic key from CPU 110, encrypt/decrypt the packet, and send the encrypted/decrypted packet back to CPU 110 for further processing.

In one wireless network environment where access point 100 is connected through a cloud or Internet to a remote controller, a secure communication tunnel, such as an IPSec tunnel, is established between access point 100 and the remote controller. Any packets transmitted through the secure tunnel between access point 100 to the remote controller need to be encrypted, for example, using AES-CBC algorithm. Likewise, any packets received from the remote controller through the secure communication tunnel need to be decrypted, for example, using AES-CBC algorithm. The AES-CBC algorithm stands for Advanced Encryption Standard (AES) Cipher Algorithm in Cipher Block Chaining (CBC) Mode (see IETF RFC 3602, which is incorporated herein).

Note that, security engine 120 can be loaded with other cipher algorithms to support other security protocols. For example, for security mechanisms in accordance to IEEE 802.111 standard (2004), both AES-CBC and AES-CTR algorithms are used for encryptions and decryptions of the packets. AES-CTR standards for Advanced Encryption Standard Counter Mode. A mode of operation is a technique for enhancing the effect of a cryptographic algorithm or adapting the algorithm for an application such as applying a block cipher to a sequence of data blocks or a data stream. Other AES block cipher modes of operation supported by security engine 120 may include, but are not limited to, electronic codebook (ECB), cipher feedback mode (CFB), output feedback mode (OFB), besides above-mentioned cipher block chaining (CBC) and counter mode (CTR).

Other wireless security protocols, such as Temporal Key Integration Protocol (TKIP) also may be supported by security engine 120. When multiple security protocols, algorithms and/or operation modes are supported by security engine 120, security engine can select the appropriate protocol, algorithm, and mode for the packet based on the interface to or from which the packet is received. Thus, if a packet is received via a port corresponding to an IPSec tunnel, security engine 120 will select AES-CBC as the algorithm and operation mode. On the other hand, if a packet is destine to a client supporting IEEE 802.11i standard, the AES-CBC and AES-CTR will both be selected by security engine 120.

When a packet requiring encryption or decryption gets processed by CPU 110, CPU 110 sends the packet to WLAN ASIC 150. WLAN ASIC 150 can retrieve a per-client based cryptographic key corresponding to the packet, and use the retrieved key to perform the desired cryptographic function.

Because the cryptographic function processing capacity of WLAN ASIC 150 is limited to a maximum number of clients supported, when WLAN ASIC 150 exceeds its capacity and is not able to process the packet, CPU 110 can retrieve a cryptographic key from a key repository and send both the packet and the retrieved cryptographic key to security engine 120. Note that, the retrieved cryptographic key is used to encrypt or decrypt only the packet. Thus, unlike the per-client based cryptographic key used by WLAN ASIC 150, the use of the CPU-retrieved cryptographic key by security engine 120 is per-packet based.

### WLAN ASIC

WLAN ASIC is a hardware chip providing WLAN access. Specifically, regarding wireless security, WLAN ASIC can receive a packet from the main CPU. The WLAN ASIC also identifies a client (or station, STA) corresponding to the packet based on contents of the packet (e.g., a header field). The WLAN ASIC then retrieves a cryptographic key for the identified client from a cryptographic key table, and use the retrieved cryptographic key to encrypt or decrypt the packet. It is important to note that the WLAN ASIC uses the same cryptographic key for packets corresponding to the same client, and the cryptographic key is unique to each client. Also, note that, the cryptographic function capacity of the WLAN ASIC is often limited by the maximum number of per-client cryptographic keys that can be stored in a fast memory accessible to the WLAN ASIC.

FIG. 2 illustrates an exemplary key table used by the WLAN ASIC according to embodiments of the present disclosure. FIG. 2 includes at least two columns: STA MAC 210 and Crypto Key 220. STA MAC 210 includes a plurality of MAC addresses, such as MAC₁, MAC₂, etc. Each MAC address uniquely identifies a client supported by the WLAN ASIC. Crypto key 22 includes a plurality of cryptographic keys used by the WLAN ASIC to encrypt/decrypt packets, such as Keyₐ, Key_{b}, etc. Each cryptographic key uniquely corresponds to a client supported by the WLAN ASIC.

### Security Ermine

FIG. 3 illustrates an exemplary hardware security engine module according to embodiments of the present disclosure. The security engine illustrated in FIG. 3 is designed to offload computationally intensive security functions, such as key generation and exchange, authentication, bulk encryption from the CPU core of the system-on-chip (SoC). The security engine hardware module can be optimized to process all cryptographic algorithms associated with Internet Protocol Security (IPsec), Internet Key Exchange (IKE), Secure Sockets Layer/Transport Layer Security (SSL/TLS), Internet Small Computer System Interface (iSCSI), Secure Real Time Transport Protocol (SRTP), IEEE 802.11i protocol, Worldwide Interoperability for Microwave Access (WiMAX), etc.

Specifically, the security engine includes controller 310, polychannel 320, and a number of execution units 380, including PKEU 350, RNGU 355, DEU 360, AESU 365, MDEU 370, CRCU 375, etc.

Controller 310 generally controls the entire security engine, such as assignment, status, identification, master control, etc. Each execution unit provides a specific cryptographic function assigned by a particular channel.

Polychannel 320 contains multiple (typically four) channels. Each channel is used to provide a particular cryptographic function assigned to a particular execution unit. Each channel could be associated to any of the execution units 380, but only one execution unit can associated to a specific channel.

The purpose of channeling is to enable the multiple cryptographic processing. In some embodiments, a user may use a simple round robin scheduling or prioritized scheduling to utilize the multiple channels. Accordingly, a user may process up to four cryptographic processing in parallel. In some embodiments, compound cryptographic processing may be performed when, for example, a cryptographic input is taken from a previous cryptographic processing output.

Execution units 380 are coupled to controller 310 through internal bus 390. Execution units 380 include Public Key Execution Unit (PKEU) 350, Random Number Generator Unit (RNGU) 355, Data Execution Unit (DEU) 360, Advanced Encryption Standard Unit (AESU) 365, Message Digest Execution Unit (MDEU) 370, Cyclical Redundancy Check Unit (CRCU) 375, etc. As illustrated in FIG. 3, DEU 360 and AESU 365 are equipped by an input first-in-first-out (FIFO-in) and output first-in-first-out (FIFO-out) mechanism; RNGU 355 is equipped with only an FIFO-out mechanism; and, MDEU 370 and CRCU 375 are equipped with FIFO-in mechanism only.

Controller 310 in particular, can act as a master on system bus 330, allowing the security engine to offload the data movement bottleneck normally associated with slave-only cores via slave interface 340. A host processor accesses the security engine through its device drivers using system memory for data storage. The security engine resides in the peripheral memory map of the processor. When an application requires cryptographic functions, the application creates descriptors for the security engine, which defines the functions to be performed and the locations of the data. For example, with a single 64-bit write, the host processor may en-queue a descriptor pointer in the security engine. The security engine's bus-mastering capability then enables, via mater interface 345, the security engine to execute the entire cryptographic task, performing reads and writes on system memory as needed.

A typical security engine operation begins when a host processor writes a descriptor pointer to the fetch FIFO in one of the four virtual channels in polychannel 320. This write operation uses slave interface 340, where the host is the master and the security engine is the slave. Following the write operation, the channel directs the sequence of operations using master interface 345, where the security engine is the master. The channel uses the descriptor pointer to read the descriptor, and subsequently decodes the first word of the descriptor to determine the operation to be performed and the crypto-execution unit(s) needed to perform it. If necessary, the channel waits for the needed crypto-execution unit(s) to be free.

Next, channel 320 requests controller 310 to transfer keys, context, and data from memory locations specified in the descriptor be sent to the appropriate execution units 380. Controller 310 satisfies the requests through its master interface 345. Data is fed into execution units 380 through their registers and input FIFOs (if applicable). Execution units 380 read from their input FIFOs (if applicable) and write processed data to their output FIFOs (if applicable) and registers. Channel 320 requests controller 310 to write data from the output FIFOs and registers back to system memory. Also, channel 320 can signal to the host that it is done with a descriptor by interrupt or by a writeback of the descriptor header into host memory.

The cryptographic driver includes four basic components: (1) driver initialization and setup; (2) application request processing; (3) interrupt service routine; and, (4) deferred service routine. While executing a request, the cryptographic driver runs in system or kernel state for all components with the exception of the ISR, which runs in the operating system's standard interrupt processing context.

Operation of the security engine core under the kernel mode is described below—Once the driver has been loaded into the CPU kernel, which will initialize the device, and also register the device to operating system specific cryptographic application programming interface (API). In the kernel mode, request completion may be handled through the standard use of notification callbacks in the cryptographic API. The example suite for the driver is provided to accomplish such request completion. This suite uses a mutex that the callback will release in order to allow the request to complete, although the caller may make use of any other type of event mechanism that suits their preference. Logical to physical memory space translation is handled internal to the driver.

The following kernel export symbol can be used to submit asynchronous crypto requests:

static inline int crypto_ablkcipher_setkey(struct crypto_ablkcipher
*tfm, const u8 *key, unsigned int keylen)
static inline struct crypto_ablkcipher
*crypto_ablkcipher_reqtfm(struct ablkcipher_request *req)
static inline int crypto_ablkcipher_encrypt(struct ablkcipher_request
*req)
static inline int crypto_ablkcipher_decrypt(struct ablkcipher_request
*req)

In addition, since the driver registers with the cryptographic kernel API, the driver can be used through a generic cryptographic interface described in a later section of the present disclosure.

### Cryptographic Function Offloading

Multiple cryptographic function offloading mechanisms can be used to offload cryptographic functions from WLAN ASIC, which performs per-user based cryptographic functions, to security engine, which performs per-packet based cryptographic functions.

First, a wireless access point can use host-side security engine in blocking mode. For example, when a maximum key threshold (e.g., 50 keys) is met, the CPU can revert to host-side encryption, but utilizing the host-side security engine hardware in blocking mode. This will reduce the software-related costs while providing good performance. However, in blocking mode, the host CPU cannot perform other operations while waiting for cryptographic operations to complete. Thus, this approach may impose additional host CPU load.

Alternatively, the wireless access point can enhance driver/security engine interface for non-blocking mode, in which the host CPU can perform other tasks. Specifically, driver software transmit thread is broken into two separate work queues. One work queue schedules the cryptographic operation (when needed), for example, by starting the cryptographic operation. Then, upon getting a completion interrupt, the other work queue schedules the regular transmit path. The two work queues work in parallel as a pipeline. Note that, the order of transmission will be maintained since the cryptographic functions are offloaded from WLAN ASIC to the security engine on a per-client basis. Furthermore, the offloading policy can be customized based, for example, to utilize LIFO, FIFO, or LRU.

In addition, the offloading policy can be optimized. For example, the wireless access point may determine whether a particular client is a heavy user of the network or a light user of the network based on the amount of time the particular client associates with the network in the recent past. On the one hand, if the wireless access point determines that the particular client is a light network user, the packets corresponding to the particular client will be offloaded to the security engine for per-packet based cryptographic function processing. On the other hand, if the wireless access point determines that the particular client is a heavy network user, the packets corresponding to the particular client will be processed by the WLAN ASIC on a per-client basis. Because the cryptographic key table used by WLAN ASIC is stored in a fast memory, it will take less time for WLAN ASIC to retrieve a cryptographic key for a client than the CPU to retrieve a cryptographic key for a packet. Therefore, it is advantageous to use WLAN ASIC for heavy network clients.

### Cryptographic Application Programming Interface

FIG. 4 illustrates an exemplary hardware security engine module according to embodiments of the present disclosure. In FIG. 4, kernel cryptographic API architecture 400 includes at least the following layers of logic: kernel interface 410, core logic 420, application management 430, algorithm implementation 440, etc.

Note that, kernel cryptographic API architecture 400 is layered such that core logic 420 is hidden from cryptography users who generally use application management 430 layer functions, as well as from algorithm implementors who generally use algorithm implementation 440 layer functions.

Core logic 420 includes generic transform management, scatterlist manipulation and abstraction of underlying algorithms. Moreover, core logic 420 may include one or more sub-logics, which may include, but is not limited to, a generic transform logic, a cipher logic, a digest logic, a completion logic, a page vector (scatterlist) logic, etc. The cipher logic, which provides ciphering operations in one or more cipher processing modes, may be operating on a per-algorithm-type basis. Likewise, sub-logics such as the digest logic, which utilizes digests for generating message authentication codes, may also be operating on a per-algorithm-type basis.

Below are a few examples of API functions that may be provided by core logic 420.

(1) Cipher Attach

This API function can be invoked for each virtual access point (VAP); and, a transform will be stored on a per-VAP basis.

void
aruba_cipher_init(void);
int
cipher_aes_ccm_mac(unsigned int *rk, const size_t key_len,

const unsigned char *nonce,
const size_t aad_len,
const unsigned char *aad,
const size_t data_len,
const unsigned char *ptxt,
unsigned char *mac);

int
cipher_aes_ctr_crypt(unsigned int *rk,

const size_t key_len,
const unsigned char *nonce,
const size_t data_len,
const unsigned char *ptxt,
unsigned char *ctxt);

(2) Cipher Setkey

This API function can be invoked once after key negotiation is complete for a station, which has been identified as a station that has overflowed the cryptographic key table.

int cipher_setkey(struct crypto_ablkcipher*tfm, const u8*key, unsigned int keylen)

(3) Cipher Request

This API function can be invoked on a per-packet basis. In some embodiments, the request can be allocated on a per-MSDU basis. MSDU generally refers to MAC Service Data Unit. Specifically, the MSDU is the service data unit that is received from the logical link control (LLC) sub-layer which lies above the medium access control (MAC) sub-layer in a protocol stack.

int cipher_req(struct crypto_ablkcipher*tfm, int enc, struct sdu*msdu)

### Processes for Offloading Cryptographic Functions to Support a Large Number of Clients

FIG. 5 is a flowchart illustrating an exemplary process of distributed network layer mobility for unified access networks according to embodiments of the present disclosure.

During operations, the disclosed network device receives a packet corresponding to a client device via an interface (operation 510). Further, one or more cryptographic operations are to be performed on the received packet.

Next, the disclosed network device determines whether a first hardware module that performs cryptographic operations on a per-client basis has overflowed (operation 520). If so, the disclosed network device retrieves a cryptographic key for the received packet (operation 530); and subsequently, sends the received packet and the retrieved cryptographic key to a second hardware module that performs cryptographic operations on a per-packet basis to perform the one or more cryptographic operations (operation 540).

If, however, the disclosed network device determines that the first hardware module that performs cryptographic operations has not overflowed, the disclosed network device will then send the received packet to the first hardware module that performs cryptographic operations on a per-client basis to perform the one or more cryptographic operations (operation 550).

According to embodiments of the present disclosure, network services provided by a wireless access point, solely or in combination with other wireless network devices, include, but are not limited to, an Institute of Electrical and Electronics Engineers (IEEE) 802.1x authentication to an internal and/or external Remote Authentication Dial-In User Service (RADIUS) server; an MAC authentication to an internal and/or external RADIUS server; a built-in Dynamic Host Configuration Protocol (DHCP) service to assign wireless client devices IP addresses; an internal secured management interface; Layer-3 forwarding; Network Address Translation (NAT) service between the wireless network and a wired network coupled to the network device; an internal and/or external captive portal; an external management system for managing the network devices in the wireless network; etc.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in non-transitory fashion in a computer-readable storage medium (e.g., a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; or any connector for receiving a portable memory device such as a Universal Serial Bus “USB” flash drive), which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “digital device” generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like.

As used herein, “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

As used herein, the term “interconnect” or used descriptively as “interconnected” is generally defined as a communication pathway established over an information-carrying medium. The “interconnect” may be a wired interconnect, wherein the medium is a physical medium (e.g., electrical wire, optical fiber, cable, bus traces, etc.), a wireless interconnect (e.g., air in combination with wireless signaling technology) or a combination of these technologies.

As used herein, “information” is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

As used herein, “wireless local area network” (WLAN) generally refers to a communications network links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

As used herein, the term “mechanism” generally refers to a component of a system or device to serve one or more functions, including but not limited to, software components, electronic components, electrical components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. Likewise, where a reference to a standard is made in the present disclosure, the reference is generally made to the current version of the standard as applicable to the disclosed technology area. However, the described embodiments may be practiced under subsequent development of the standard within the spirit and scope of the description and appended claims. The description is thus to be regarded as illustrative rather than limiting.

What is claimed is:

1. A method comprising:
receiving, by a network device comprising one or more processor cores, a packet corresponding to a client device via an interface, wherein one or more cryptographic operations are to be performed on the received packet;
determining, by the network device, whether a first hardware module that performs cryptographic operations on a per-client basis overflows; and
in response to the first hardware module overflowing, sending the received packet to a second hardware module that performs cryptographic operations on a per-packet basis.

2. The method of claim 1, wherein the first hardware module comprises a wireless local area network (WLAN) application-specific integrated circuit (ASIC), and wherein the second hardware module comprises a CPU security engine (SEC).

3. The method of claim 2, further comprising:
determining a client identifier uniquely associated with the client device based on the received packet;
retrieving, by the WLAN ASIC, a cryptographic key based on the client identifier from a cryptographic key table stored in a fast memory; and
using the retrieved cryptographic key to perform the one or more cryptographic operations by the WLAN ASIC.

4. The method of claim 1, further comprising: in response to the first hardware module overflowing,
retrieving a cryptographic key for the received packet; and
sending the received packet and the cryptographic key for the received packet to the second hardware module that uses the cryptographic key for the received packet to perform the one or more cryptographic operations.

5. The method of claim 1, wherein the second hardware module uses a plurality of cipher mechanisms in a plurality of operation modes to support a plurality of wireless network security protocols.

6. The method of claim 5, wherein the plurality of wireless network security protocols comprises Internet Protocol Security (IPsec), Internet Key Exchange (IKE), Secure Sockets Layer/Transport Layer Security (SSL/TLS), Internet Small Computer System Interface (iSCSI), Secure Real Time Transport Protocol (SRTP), IEEE 802.111 protocol, Worldwide Interoperability for Microwave Access (WiMAX).

7. The method of claim 5, wherein the plurality cipher mechanisms comprises Advanced Encryption Standard (AES) and Temporal Key Integration Protocol (TKIP).

8. The method of claim 5, wherein the plurality of operation modes comprises Cipher Block Chaining mode (CBC), electronic codebook (ECB), cipher feedback mode (CFB), output feedback mode (OFB), and counter mode (CTR).

9. The method of claim 1, wherein the second hardware module offloads from the first hardware module computationally intensive security operations comprising key generation and exchange, authentication, bulk encryption from the one or more processing cores.

10. The method of claim 1, wherein the second hardware module offloads from the first hardware module security operations corresponding to a plurality of client devices that are associated with light network usages based on their historical network usage information.

11. The method of claim 1, wherein a driver for the second hardware module uses an application programming interface that provides one or more of the following functionalities: creating a cryptographic transform, setting a cryptographic key after key negotiation for an overflow client device is completed, and cipher request on a per-MAC Service Data Unit (MSDU) basis.

12. A network device comprising:
one or more processors;
a memory;
a receiving mechanism coupled to the one or more processors, the receiving mechanism to receive a packet corresponding to a client device via an interface, wherein one or more cryptographic operations are to be performed on the received packet;
a determining mechanism coupled to the one or more processors, the determining mechanism to determine whether a first hardware module that performs cryptographic operations on a per-client basis overflows; and
an internal-transmitting mechanism coupled to the one or more processors, the internal-transmitting mechanism to send the received packet to a second hardware module that performs cryptographic operations on a per-packet basis in response to the first hardware module overflowing.

13. The network device of claim 12, wherein the first hardware module comprises a wireless local area network (WLAN) application-specific integrated circuit (ASIC), and wherein the second hardware module comprises a CPU security engine (SEC).

14. The network device of claim 13,
wherein the determining mechanism further to determine a client identifier uniquely associated with the client device based on the received packet; and
wherein WLAN ASIC further to
retrieve a cryptographic key based on the client identifier from a cryptographic key table stored in a fast memory, and
use the retrieved cryptographic key to perform the one or more cryptographic operations.

15. The network device of claim 12, wherein, in response to the first hardware module overflowing, the determining mechanism further to retrieve a cryptographic key for the received packet, and the internal-transmitting mechanism further to send the received packet and the cryptographic key for the received packet to the second hardware module that uses the cryptographic key for the received packet to perform the one or more cryptographic operations.

16. The network device of claim 12, wherein the second hardware module uses a plurality of cipher mechanisms in a plurality of operation modes to support a plurality of wireless network security protocols.

17. The network device of claim 16, wherein the plurality of wireless network security protocols comprises Internet Protocol Security (IPsec), Internet Key Exchange (IKE), Secure Sockets Layer/Transport Layer Security (SSL/TLS), Internet Small Computer System Interface (iSCSI), Secure Real Time Transport Protocol (SRTP), IEEE 802.111 protocol, Worldwide Interoperability for Microwave Access (WiMAX).

18. The network device of claim 16, wherein the plurality cipher mechanisms comprises Advanced Encryption Standard (AES) and Temporal Key Integration Protocol (TKIP).

19. The network device of claim 16, wherein the plurality of operation modes comprises Cipher Block Chaining mode (CBC), electronic codebook (ECB), cipher feedback mode (CFB), output feedback mode (OFB), and counter mode (CTR).

20. The network device of claim 12, wherein the second hardware module offloads from the first hardware module computationally intensive security operations comprising key generation and exchange, authentication, bulk encryption from the one or more processing cores.

21. The network device of claim 12, wherein the second hardware module offloads from the first hardware module security operations corresponding to a plurality of client devices that are associated with light network usages based on their historical network usage information.

22. The network device of claim 12, wherein a driver for the second hardware module uses an application programming interface that provides one or more of the following functionalities: creating a cryptographic transform, setting a cryptographic key after key negotiation for an overflow client device is completed, and cipher request on a per-MAC Service Data Unit (MSDU) basis.

23. A non-transitory computer-readable storage medium storing embedded instructions that are executed by one or more mechanisms implemented within a network device to perform a plurality of operations comprising:
receiving a packet corresponding to a client device via an interface, wherein one or more cryptographic operations are to be performed on the received packet;
determining whether a first hardware module that performs cryptographic operations on a per-client basis overflows; and
sending the received packet to a second hardware module that performs cryptographic operations on a per-packet basis in response to the first hardware module overflowing.
